(19) United States
(12) Patent Application Publication
(10) Pub. No.: US 2025/0146190 A1
(43) Pub. Date: May 8, 2025

(54) Textilene Mesh Fabric and Application

(71) Applicant: ZHEJIANG SANMEN VIAIR INDUSTRY CO., LTD, Taizhou (CN)

(72) Inventor: Xiaopeng Yu, Taizhou (CN)

(21) Appl. No.: 18/415,749

(22) Filed: Jan. 18, 2024

(30) Foreign Application Priority Data
Nov. 8, 2023 (CN) 202311481046.5

(51) Int. Cl. D03D 9/00; D01D 5/088; D01D 10/00; D03D 1/00; D03D 15/283; D03D 15/292; D03D 15/47; D03D 15/573

(52) U.S. Cl. CPC D03D 9/00; D01D 5/0885; D01D 10/00; D03D 1/00; D03D 15/283; D03D 15/292; D03D 15/47; D03D 15/573; D10B 2321/041; D10B 2331/04; D10B 2505/12

(57) ABSTRACT

The present invention discloses a Textilene mesh fabric and its application, which comprises warp yarns and weft yarns interwoven; the warp yarns comprise the first warp yarns and the second warp yarns, and the weft yarns comprise the first weft yarns and the second weft yarns; the first warp yarns and the first weft yarns are PVC threads, and the second warp yarns and the second weft yarns are polyester synthetic fibers. The present invention uses the polyester synthetic fiber to replace the traditional polyester yarn, and mixes with PVC thread prepared by the thread production mechanism to weave the Textilene mesh fabric that has an elongation ratio of more than 30% under high-temperature softening.

### CROSS REFERENCE TO RELATED APPLICATIONS

The present application claims the benefit of Chinese Patent Application No. 202311481046.5 filed on Nov. 8, 2023, the contents of which are incorporated herein by reference in their entirety.

### TECHNICAL FIELD

The invention belongs to the technical field of cloth and in particularly relates to a Textilene mesh fabric and an application thereof.

### BACKGROUND ART

Conventional Textilene mesh fabric is a special textile woven by shuttleless loom from composite yarns of special coating structure, mainly PVC/PET sheath-core yarns. The core is high-strength polyester industrial filament, and the sheath is made of aging resistant and ultraviolet radiation resistant PVC material. Polyester filaments are stretched to coat PVC sheath, and then are polished and cooled to form composite threads, which are woven into a mesh by rapier loom through warping process, and finally shaped into the final product. However, due to the existence of plenty high-strength polyester filaments, conventional Textilene is restricted by tensile length in the warp and weft directions. When traditional Textilene mesh fabric is used as the material of 3D car mats, the restricted tensile length during molding results in difficult 3D modeling and breaking filaments partially.

When coreless PVC threads are used to weave Textilene mesh fabric, they are extruded by traditional plastic thread extruding machine, which utilizes the plasticity and elongation of plastics to process molten PVC into thin threads by stretching and extruding. The thickness of PVC thread is controlled by the extrusion die core, traction of the stretching machine and temperature. In view of the characteristics of PVC material and the extruding process, PVC monofilament has a high shrinkage rate after heating. And Textilene mesh fabric must be baked at 150° C.-170° C. for softening before being processed to 3D molded car mats. Therefore, it is inevitable for conventional PVC threads to have shrinkage and deformation problems after heating, which will also lead to the deformation of composite car mats braided from pure PVC threads, such as uneven woven cloth and irregular patterns, or delamination of PVC mesh fabric from the substrate.

### SUMMARY OF THE INVENTION

In order to overcome the deficiencies in the prior art, the present invention provides a Textilene mesh fabric and an application thereof.

In order to achieve the above objectives, the present invention adopts the following technical solutions: a Textilene mesh fabric, comprises warp yarns and weft yarns interwoven; the warp yarns comprise the first warp yarns and the second warp yarns, and the weft yarns comprise the first weft yarns and the second weft yarns; the first warp yarns and the first weft yarns are PVC threads, and the second warp yarns and the second weft yarns are polyester synthetic fibers.

Further, the warp yarns are a mixed combination of 75% PVC threads and 25% polyester synthetic fibers, and the weft yarns are a mixed combination of 75% PVC threads and 25% polyester synthetic fibers.

Further, the diameter of the PVC threads is 0.5-0.7 MM, and the thickness of the polyester synthetic fibers is 50 D-200 D.

Further, the breaking strength of the PVC threads and the polyester synthetic fibers is set at 3.3CN/dtex-4.2CN/dtex.

Further, the PVC threads are prepared by a thread production mechanism, which comprises a raw material mixer, a granulator, a filament former, a stretching machine and a winder, wherein the raw material mixer is used for mixing raw materials of the PVC thread, the granulator extrudes the raw materials for granulation, the filament former forms monofilaments, the stretching machine stretches and thermally contracts the monofilaments into filaments, and the winder winds the filaments.

Further, the raw materials of the PVC thread include polyvinyl chloride resin, dioctyl phthalate, dibutyl phthalate, tribasic lead sulfate, dibasic lead sulfite, barium stearate, stearic acid, activated calcium, titanium dioxide, UV-P, bisphenol A, chlorinated paraffin and tricresyl phosphate, with each raw material of 100:3:5:2:2:0.7:0.6:5:2:0.5:0.5:1:4 respectively counted by Phr.

Further, the filament former comprises an extruder, a die core and a cooling water bath that are arranged in sequence; the extruder and the die core extrude monofilaments; the die core is a right-angle die; the internal flow channel is flared, with the diameter ratio of the two ends of 3:1; the divergent cone expansion angle is 45 degrees; the radius of the holes in the spinneret of the die core is 0.6 mm, and length-diameter ratio is 8:1; the number of holes is 50; the drawing ratio is 4 times; the temperature of the monofilaments from the spinneret holes is 180° C.; the monofilaments are cooled in the cooling water bath, and the water temperature in the cooling water bath is controlled at 30-40° C.

Further, the temperature of the extruder barrel is gradually ascending from the feeding section (130° C.) to the extrusion die core (180° C.).

Further, the stretching machine comprises a boiling water bath, a first constant temperature oven, a second constant temperature oven and a cooling zone that are arranged in sequence; a first traction is arranged between the cooling water bath and the boiling water bath, wherein the first traction draws monofilaments from the cooling water bath to the boiling water bath for heat treatment; a second traction is arranged between the boiling water bath and the first constant temperature oven, wherein the second traction draws monofilaments from the boiling water bath to the first constant temperature oven for heat treatment; a third traction is arranged between the first constant temperature oven and the second constant temperature oven, wherein the third traction is low traction, and draws the monofilaments to the second constant temperature oven for heat treatment; and the monofilaments after heat treatment are cooled in the cooling zone.

An application of the Textilene mesh fabric, the Textilene mesh fabric is applied to 3D car mats.

Further, the breaking strength of the PVC threads and the polyester synthetic fibers is set at 3.3CN/dtex-4.2CN/dtex.

Compared with the prior art, the present invention has the following beneficial effects:

1) The present invention uses polyester synthetic fiber to replace traditional polyester yarns, and uses the thread production mechanism to extrude PVC threads, and then mix and weave the Textilene mesh fabric that has the elongation of more than 30% under high temperature softening.

2) By the addition of three-stage heat treatment after traction, monofilaments are heat treated in the process to avoid excessive shrinkage caused by heat in the molding process of car mats and curling and delamination of surface layer of the finished Textilene products; At the same time, the heat treatment temperature and traction force in each stage are controlled, so that the filaments can be stretched and shrunk to the set requirements; In addition, monofilaments have certain requirements on strength in the molding process. In this invention, the stretching ratio is set to 4, and the monofilaments are heat-treated in the boiling water bath; and the rotation speed of the third traction is 5%-8% lower than that of the second traction, so as to attain stable quality of monofilaments, raise the heat shrinkage temperature and reduce contraction.

3) The present invention improves the proportion of raw materials of the PVC threads, which to a certain extent solves the problem of thermal shrinkage caused by high-temperature softening before molding of Textilene mesh fabrics that are woven by PVC threads, and satisfies the requirements of 3D molding of car mats.

4) With the stretching machine in the present invention, the monofilaments are subjected to heat treatment in the first constant-temperature oven and the second constant-temperature oven, and the thermal stability of the filaments is improved through twice shrinkage; compared with the conventional stretching machine, three-stage heat treatment is added in this application, so that the finished monofilaments are pre-shrunk to ensure the thermal shrinkage stability of Textilene mesh fabric.

### BRIEF DESCRIPTION OF THE DRAWINGS

FIG. 1 is a schematic diagram of interweaving of Textilene mesh fabric of the present invention.

FIG. 2 is a schematic diagram of the thread production mechanism of the present invention.

### DETAILED DESCRIPTION

The following embodiments are used to illustrate the implementation of the invention, and those skilled in the art can easily understand other advantages and effects of the invention from the contents disclosed in this Specification. This invention can also be implemented or applied through other specific embodiments, and various details in this Specification can be modified or changed based on different viewpoints and applications without deviating from the spirit of the invention.

It should be noted that without conflict, the following embodiments and characteristics in the embodiments can be combined with each other.

It should be noted that the illustrations provided in the following embodiments only illustrate the basic concept of the invention in a schematic way. Therefore, only the components related to the invention are shown in the drawings, instead of being drawn according to the number, shape and size of the components actually implemented. The types, numbers and proportions of each component in actual implementation may be changed at will, and the layout of the component may be more complicated.

All directional indications (such as up, down, left, right, front, back, horizontal, vertical, etc.) in the embodiment of the invention are only used to explain the relative positions and movement situation among components in a certain posture, and if the certain posture changes, the directional indications will change accordingly.

Due to installation errors and other reasons, the parallel relationship referred to in the embodiment of the present invention may actually be approximately parallel, and the vertical relationship may actually be approximately vertical.

### Method 1:

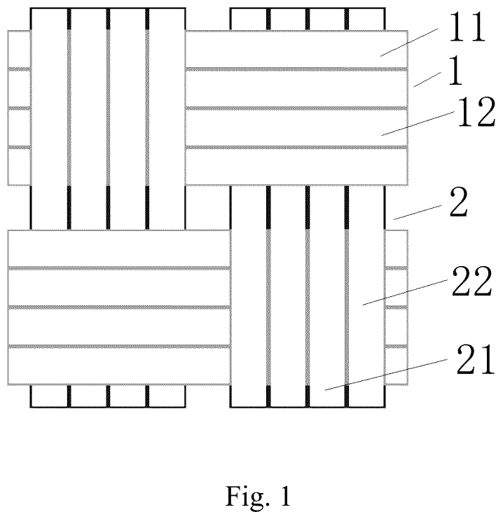

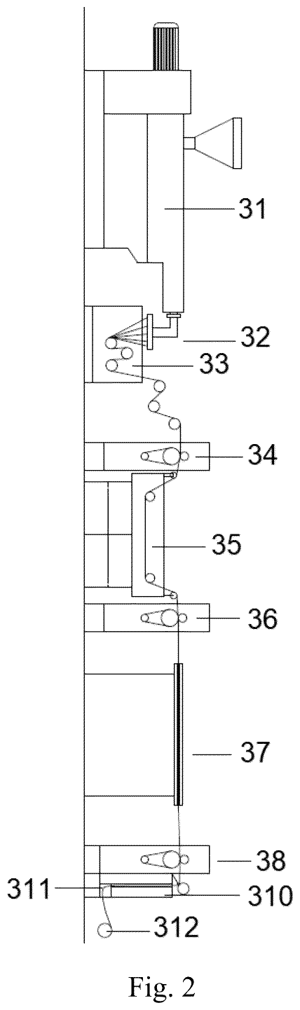

As shown in FIGS. 1-2, a Textilene mesh fabric comprises warp yarns 1 and weft yarns 2, which are interwoven; the warp yarns 1 comprise first warp yarns 11 and second warp yarns 12, and the weft yarns 2 comprise first weft yarns 21 and second weft yarns 22; the first warp yarns 11 and the first weft yarns 21 are PVC threads, and the second warp yarns 12 and the second weft yarns 22 are PVC-coated polyester synthetic fibers.

The PVC-coated polyester synthetic fiber is the polyester synthetic fiber filament core coated with PVC.

Warp yarns 1 is a mixed combination of PVC threads and PVC-coated polyester synthetic fibers, weft yarns 2 is a mixed combination of PVC threads and PVC-coated polyester synthetic fibers, and Textilene mesh fabrics are interwoven by warp yarns 1 and weft yarns 2, with an elongation ratio of more than 30% under the high-temperature softening before the molding of car mats. Compared with the low elongation ratio of only 3% of conventional Textilene, this mesh fabric can meet the high-temperature elongation requirement of 3D molded car mat material of over 30%. Therefore it can be used as a component of 3D car mat material with Textilene mesh fabric as the surface layer.

The number of the first warp yarns 11 and the second warp yarns 12 is at least one respectively, the number of the first weft yarns 21 and the second weft yarns 22 is at least one respectively, and the specific number is subject to actual needs. In this embodiment, there are three first warp yarns 11, one second warp yarn 12, three first weft yarns 21 and one second weft yarn 22.

Preferably, the first warp yarns 11 and the second warp yarns 12 are arranged in parallel, and the first weft yarns 21 and the second weft yarns 22 are arranged in parallel.

In this embodiment, the warp yarns 1 are a mixed combination of 75% first warp yarns 11 and 25% second warp yarns, and the weft yarns 2 are a mixed combination of 75% first weft yarns 21 and 25% second weft yarns 22. The core of this application adopts polyester synthetic fiber to replace the traditional polyester yarn, and the proportions of the first warp yarns 11 and the second warp yarns 12, and the first weft yarns 21 and the second weft yarns 22 make the elastic elongation of the warp yarns 1 and the weft yarns 2 greater than 3000.

The thickness of the first warp yarns 11 or/and the first weft yarns 21 is required to be 0.5-0.7 mm, the breaking strength is required to be 3.3CN/dtex-4.2CN/dtex, and the thickness of the core of the second warp yarns 12 or/and the second weft yarns 22 is required to be 50 D-200 D, and the breaking strength is required to be 3.3CN/dtex-4.2CN/dtex. The thickness of filament of the second warp yarns 12 or/and the second weft yarns 22 is required to be 900 D-1100 D. The thickness and breaking strength requirement of the second warp yarns 12 can ensure that the core is partially broken in highly stretched area during the molding process of Textilene mesh fabric, so that it is not easy to restore after cooling and shaping.

Textilene mesh fabrics are interwoven by warp yarns 1 and weft yarns 2, which reduces the core strength of Textilene mesh fabric and makes the elongation more than 30% under high temperature softening.

TABLE 1

| Test | | Core | Yarn | | | Elongation |
|---|---|---|---|---|---|---|
| Method | Coated Core | Thickness | Thickness | Strength | | Ratio |
| Scheme 1 | High strength | 300 D | 550 D | 8.5 | cN/dex | 3%-5% |
| | polyester yarn | | | | | |
| Scheme 2 | High strength | 150 D | 550 D | 6 | cN/dex | 3%-5% |
| | polyester yarn | | | | | |
| Scheme 3 | PE yarn | 150 D | 550 D | Hot melt, | | |
| | | | | structural failure | | |
| Scheme 4 | Coreless | / | 550 D | 1.2 | cN/dex | 80%-120% |
| | PVC yarn | | | | | |
| Scheme 5 | Polyester | 150 D | 550 D | 3.6 | cN/dex | 36%-40% |
| | synthetic fiber | | | | | |
| Scheme 6 | PVC yarn | / | 900~1100 D | 4 | cN/dex | >40% |

Table 1 above lists the elongation test data of the coated core as the weaving yarns for Textilene mesh fabric after being baked at 150° C. for 3 minutes, in which Scheme 1-Scheme 4 are conventional weaving yarns for Textilene mesh fabric, and Scheme 5 and Scheme 6 are the weaving yarns in this application. According to Table 1, when weaving Textilene mesh fabrics with high-strength polyester yarns, the elongation is 3%-5%, not meeting the requirements of 3D molded car mats. In Scheme 3, when weaving Textilene mesh fabrics with PE yarns, hot melting and structural damage problems arise. In Scheme 5, when weaving Textilene mesh fabrics with polyester synthetic fiber, the elongation rate reaches 36%-40%, which meets the requirements of 3D molded car mats. In Scheme 6, the Textilene mesh fabrics are woven with PVC yarns prepared by the above-mentioned thread production mechanism, and the elongation rate exceeds 40%, meeting the requirements of 3D molded car mats. To sum up, Textilene mesh fabrics woven by polyester synthetic fiber and PVC yarns can be used as the material of 3D molded car mats.

The PVC yarns of Textilene mesh fabric are prepared by a thread production mechanism, which comprises a raw material mixer, a granulator, a filament former, a stretching machine and a winder 312, wherein the raw material mixer is used for mixing raw materials of the PVC yarns, the granulator extrudes the raw materials for granulation, the filament former forms monofilaments, the stretching machine stretches and thermally contracts the monofilaments into filaments, and the winder 312 winds the filaments.

The raw material mixer has high-speed type and low-speed type. The discharge temperature range of the high-speed mixer is 108-125° C., and that of the low-speed mixer is lower than 50° C. Before the raw materials are mixed, resin powder and compounding agent are sieved to remove impurities, so as to ensure stable stretching and reduce the breakage rate.

The raw materials of the PVC yarns include polyvinyl chloride resin, dioctyl phthalate, dibutyl phthalate, tribasic lead sulfate, dibasic lead sulfite, barium stearate, stearic acid, activated calcium, titanium dioxide, UV-P, bisphenol A, chlorinated paraffin and tricresyl phosphate, with each raw material of 100:3:5:2:2:0.7:0.6:5:2:0.5:0.5:1:4 respectively counted by Phr. Among them, activated calcium accounts for 5 Phr, which can increase the dimension stability of PVC yarns; UV-P is a light stabilizer; 0.5 Phr bisphenol A will improve the oxidation resistance of PVC yarns; 1 Phr chlorinated paraffin makes PVC yarns flame retardant and impact resistant. This application improves the proportion of raw materials of PVC yarns, which to a certain extent solves the heat shrinkage problem caused by the high temperature softening of PVC yarns as Textilene mesh braiding yarns for 3D molding of car mats.

The granulating temperature of the granulator is controlled at 185-190° C., so that the raw materials can be better plasticized and the stretching process is more stable. The granulator can be of conventional type.

The filament former comprises an extruder 31, an extrusion die core 32 and a cooling water bath 33 that are arranged in sequence. The extruder 31 and the extrusion die core 32 extrude monofilaments for molding. The extruder 31 is a single-screw universal extruder with the diameter of ΦD65 mm, the length-diameter ratio of 25:1 and the compression ratio of 3:1. The extruder ensures monofilament stretching capacity and reasonable plasticizing capacity.

The die core is a right-angle die; the internal flow channel is flared, with the diameter ratio of the two ends of 3:1; the divergent cone expansion angle is 45 degrees; the radius of the holes in the spinneret of the die core is 0.6 mm, and length-diameter ratio is 8:1; the number of holes is preferred 50. In order to ensure the thermal stability of the molded monofilament, the stretching ratio is preferred not more than 4 times, meeting R=r×\sqrt{n}, in which R is the spinneret hole radius, r is the required monofilament radius, and n is the stretching ratio.

The cooling water bath 33 is butted with the extrusion die core 32, and the temperature of the monofilament from the spinneret hole is about 180° C. The cooling water bath 33 cools the monofilament quickly to avoid adhesion and oxidation. The water temperature in the cooling water bath 33 is controlled at 30-40° C., and the size of the water bath is up to actual needs, as long as the monofilaments are fully cooled.

Preferably, the temperature of the extruder barrel is gradually ascending from the feeding section (130° C.) to the extrusion die core (180° C.), so as to ensure the internal pressure balance of the extruder 31 and uniform plasticization. The extruded melt monofilaments quickly enter the cooling water bath 33 for cooling to avoid adhesion and oxidation.

The stretching machine comprises a boiling water bath 35, a first constant temperature oven 37, a second constant temperature oven 310 and a cooling zone 311 that are arranged in sequence. A first traction 34 is arranged between the cooling water bath 33 and the boiling water bath 35. The first traction 34 draws the monofilament from the cooling water bath 33 to the boiling water bath 35 for heat treatment, so as to increase heat shrinkage temperature, reduce thermal contraction and ensure stable quality of the monofilaments. A second traction 36 is arranged between the boiling water bath 35 and the first constant temperature oven 37. The second traction 36 draws the monofilament from the boiling water bath 35 to the first constant temperature oven 37 for heat treatment. A third traction 38 (low traction) is arranged between the first constant temperature oven 37 and the second constant temperature oven 310, which draws the monofilaments to the second constant temperature oven for heat treatment. The temperature of the second constant temperature oven 310 is set at 120° C., and the heat treatment duration is 4 minutes. The third traction oven 38 and the second constant temperature oven 310 are at high temperature and low traction. The cooling zone 311 cools the heat-treated monofilaments.

The winder 312 winds the PVC filaments through constant tension, and this embodiment is driven by a conventional torque motor.

The traction speed ratio of the third traction 38 and the winder 312 is 1:0.6, and the overall speed ratio should be such that the winding speed of the winder 312 is lower than the heat treatment speed of the second constant temperature oven 310; the traction speed ratio of the first traction 34, the second traction 36 and the third traction 38 is 1:2:4; the rotation speed of the third traction 38 is 5%-8% lower than that of the second traction 36; and the stretching ratio of the monofilament is 4 times.

In this application, the first traction 34 and boiling water bath 35 perform the first-stage heat treatment of filaments in the stretching process, the second traction 36 and the first constant-temperature oven 37 perform the second-stage heat treatment of the filaments, and the third traction 38 and the second constant-temperature oven 310 perform the third-stage heat treatment of the filaments. The monofilaments are subjected to heat treatment in the first constant-temperature oven and the second constant-temperature oven, and the thermal stability of the filaments is improved through twice thermal shrinkage; compared with the conventional stretching machine, three-stage heat treatment is added in this application, so that the finished monofilaments are pre-shrunk to ensure the thermal shrinkage stability of the Textilene mesh fabric.

When traditional Textilene mesh fabric is used as the material of 3D car mats, the restricted tensile length during molding results in difficult 3D modeling and breaking filaments partially. Considering the subsequent application in 3D molded car mats, Textilene mesh fabrics shall have the elongation ratio of more than 30% and the shrinkage of less than 5% during heat treatment. This application is different from the traditional PVC stretching equipment. By the addition of three-stage heat treatment after traction, monofilaments are heat treated in the process to avoid excessive shrinkage caused by heat in the molding process of cat mats and curling and delamination of surface layer of the finished Textilene products; At the same time, the heat treatment temperature and traction force in each stage are controlled, so that the filaments can be stretched and shrunk to the set requirements; In addition, monofilaments have certain requirements on strength in the molding process. In this invention, the stretching ratio is set to 4, and the monofilaments are heat-treated in boiling water bath 35; and the rotation speed of the third traction 38 is 5%-8% lower than that of the second traction 36, so as to attain stable quality of monofilaments, raise the heat shrinkage temperature and reduce contraction.

In other embodiments where the extruder with larger screw length-to-diameter ratio produces monofilaments, the granulation process can be omitted, and powder can be extruded for plasticizing and drawing.

The application also provides an application of the Textilene mesh fabrics in the field of integrated modeling of 3D car mats. As a 3D car mat material, Textilene mesh fabric retains the advantages of wear resistance, easy cleaning, environmental protection and flame retardancy, and is attractive and elegant, thus becoming a new choice for car interior materials.

The above are only the preferred embodiments of the present invention. Based on the embodiments in the present invention, all other embodiments obtained by those of ordinary skill in the art without any creative effort should be regarded as the protection scope of the present invention.

What is claimed is:

1. A Textilene mesh fabric, characterized in that it comprises warp yarns and weft yarns interwoven, wherein the warp yarns comprise the first warp yarns and the second warp yarns, and the weft yarns comprise the first weft yarns and the second weft yarns, and the first warp yarns and the first weft yarns are PVC threads, and the second warp yarns and the second weft yarns are PVC coated polyester synthetic fibers.

2. A Textilene mesh fabric according to claim 1, characterized in that the warp yarns are a mixed combination of 75% PVC threads and 25% polyester synthetic fibers, and the weft yarns are a mixed combination of 75% PVC threads and 25% PVC coated polyester synthetic fibers.

3. A Textilene mesh fabric according to claim 2, characterized in that the thickness of the first warp yarns and the first weft yarns is 0.5-0.7 MM, and the thickness of the second warp yarns and the second weft yarns is 900 D-1100 D.

4. A Textilene mesh fabric according to claim 2, characterized in that the breaking strength of the PVC threads and the polyester synthetic fibers is 3.3CN/dtex-4.2CN/dtex.

5. A Textilene mesh fabric according to claim 1, characterized in that the PVC threads are prepared by a thread production mechanism, which comprises a raw material mixer, a granulator, a filament former, a stretching machine and a winder, wherein the raw material mixer is used for mixing raw materials of the PVC thread, the granulator extrudes the raw materials for granulation, the filament former forms monofilaments, the stretching machine stretches and thermally contracts the monofilaments into filaments, and the winder winds the filaments.

6. A Textilene mesh fabric according to claim 5, characterized in that the raw materials of the PVC thread include polyvinyl chloride resin, dioctyl phthalate, dibutyl phthalate, tribasic lead sulfate, dibasic lead sulfite, barium stearate, stearic acid, activated calcium, titanium dioxide, UV-P, bisphenol A, chlorinated paraffin and tricresyl phosphate, with each raw material of 100:3:5:2:2:0.7:0.6:5:2:0.5:0.5:1:4 respectively counted by Phr.

7. A Textilene mesh fabric according to claim 5, characterized in that the filament former comprises an extruder, an extrusion die core and a cooling water bath that are arranged in sequence; the extruder and the extrusion die core extrude monofilaments; the extrusion die core is a right-angle die; the internal flow channel is flared, with the diameter ratio of the two ends of 3:1; the divergent cone expansion angle is 45 degrees; the radius of the holes in the spinneret of the extrusion die core is 0.6 mm, and the length-diameter ratio is 8:1; the number of holes is 50; the drawing ratio is 4 times; the temperature of the monofilaments from the spinneret holes is 180° C.; the monofilaments are cooled in the cooling water bath, and the water temperature in the cooling water bath is controlled at 30-40° C.

8. A Textilene mesh fabric according to claim 7, characterized in that the temperature of the extruder barrel is gradually ascending from the feeding section (130° C.) to the extrusion die core (180° C.).

9. A Textilene mesh fabric according to claim 5, characterized in that the stretching machine comprises a boiling water bath, a first constant temperature oven, a second constant temperature oven and a cooling zone that are sequentially distributed; a first traction is arranged between the cooling water bath and the boiling water bath, wherein the first traction draws monofilaments from the cooling water bath to the boiling water bath for heat treatment; a second traction is arranged between the boiling water bath and the first constant temperature oven, wherein the second traction draws monofilaments from the boiling water bath to the first constant temperature oven for heat treatment; a third traction is arranged between the first constant temperature oven and the second constant temperature oven, wherein the third traction is low traction, and draws the monofilaments to the second constant temperature oven for heat treatment; and the monofilaments after heat treatment are cooled in the cooling zone.

10. An application of the Textilene mesh fabric according to claim 1, characterized in that the Textilene mesh fabric is applied to 3D car mats.
